(19) United States
(12) Patent Application Publication
(10) Pub. No.: US 2007/0198473 A1
(43) Pub. Date: Aug. 23, 2007

(54) Computer system displaying personal information items in database as individual files

(75) Inventor: Mark A. Carrier, Houston, TX (US)

Correspondence Address: WONG, CABELLO, LUTSCH, RUTHERFORD & BRUCCULERI LLP, 20333 SH 249, SUITE 600, HOUSTON, TX, 77070, US

(73) Assignee: SimDesk Technologies, Inc., Houston, TX (US)

(21) Appl. No.: 11/346,880

(22) Filed: Feb. 3, 2006

(51) Int. Cl. G06F 17/30

(52) U.S. Cl. 707/3

(57) ABSTRACT

An intermediate program which is provided at the PIM database server so that file system requests are treated as requests to provide responses for the contact and calendar information as interchange format files, without the need for a front end program or other specialized program on the user computer. The user opens the file manager program and requests a file listing for the server containing the PIM item database. The intermediate program receives the query from the file manager program and queries the PIM item database to determine the contact and calendar items accessible by the user. These items are then provided to the file manager program as standard interchange format files. The user then only need copy the file, at which time are intermediate program converts the proprietary database format information into the interchange file format, and attach it or paste it as desired.

### BACKGROUND OF THE INVENTION

1. Field of the Invention

The Invention relates to computer file systems and personal information management items.

2. Description of the Related Art

Personal Information Managers (PIMs) have become very useful programs. They allow an individual to maintain their contacts and calendars in very simple, yet sophisticated manners. The programs can be simple desktop programs, such as Microsoft Outlook, or large server-based programs, such as Microsoft Exchange. One commonality is that the programs treat the contract and calendar information as data stored in proprietary database formats. Because of this database nature, a front end program of some type is needed to convert between the database entries and the graphical displays preferred by users. While various standards, such as MAPI, have been developed to allow various front end programs to operate with various server-based programs, the same requirement of a specialized front end program still exists.

In parallel, file formats have been developed to allow simplified contact and calendar event sharing. The vCard format (.vcf files) is used for contacts, while iCalendar (.ics files) and vCalendar (.vcs files) are used with calendar events. When one of the files is received, conventionally opening it or double clicking it allows it to be saved with the user's other PIM items. Additionally, dragging and dropping the file into the proper portion of the front end program display also generally allows the item to be saved. However, to create one of these files for interchange, the item must be opened in a front end program and saved in the defined format. In some cases the item can be dragged and dropped, but access to the item using the front end program is still required.

Because of the complicated database formats and need to use front end programs, transfer of contact and calendar items requires several programs and various steps in each case. It would be desirable to simplify the process.

### SUMMARY OF THE PRESENT INVENTION

In systems according to the present invention, access to contact and calendar interchange files is simplified. An intermediate program is provided at the database server so that file system requests are treated as requests to provide responses for the contact and calendar information as interchange format files, without the need for a front end program or other specialized program on the user computer. The user opens the file manager program, such as Windows Explorer, and requests a file listing for the server containing the PIM item database. The intermediate program receives the query from the file manager program and queries the PIM item database to determine the contact and calendar items accessible by the user. These items are then provided to the file manager program as standard interchange format files, such as .vcf or .ics files. The user then only need copy the file, at which time are intermediate program converts the proprietary database format information into the interchange file format, and attach it or paste it as desired, such as in an email or into another folder displayed by the file manager program. There is no need to open up a front end program and then open the item and then save the item to obtain an interchange format file. The interchange format file is directly made available to the user through the use of the intermediate program.

### BRIEF DESCRIPTION OF THE DRAWINGS

FIG. 1 is a block diagram of a user computer connected to a PIM database according to the present invention.

FIG. 2 is a block diagram of various software programs used in the system of FIG. 1.

FIG. 3 is a diagram of the various entries in the PIM database of FIGS. 1 and 2.

FIG. 4 is an exemplary screen display illustrating the presentation of contact interchange format files according to the present invention.

FIG. 5 is an exemplary screen display similar to FIG. 4 but showing calendar interchange format files.

FIG. 6 is a flowchart of exemplary operations according to the present invention.

### DETAILED DESCRIPTION OF THE PREFERRED EMBODIMENT

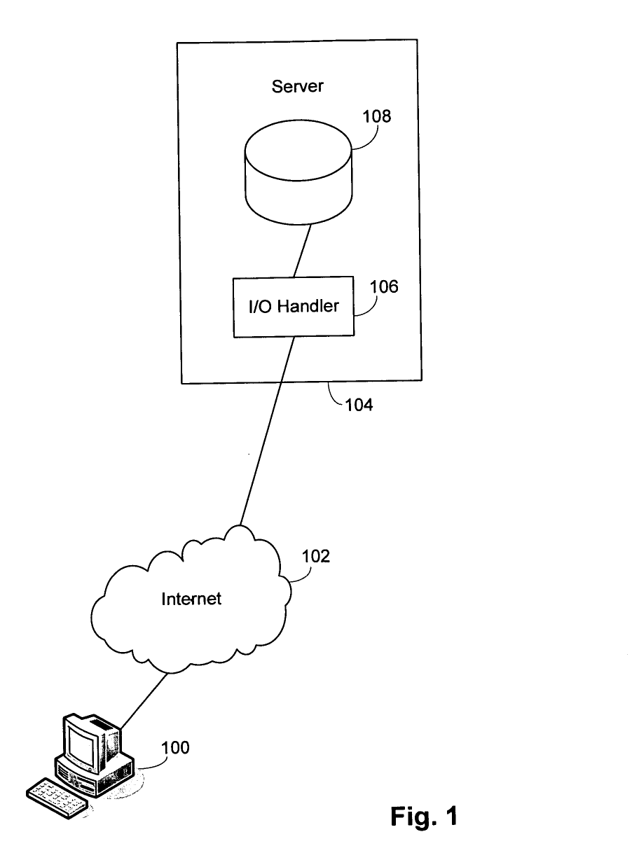

Referring now to FIG. 1, a user computer 100 is connected through a network such as the Internet 102 to a server 104. The server 104 is used to contain data files and PIM (personal information management) files or items for the user. By having the server 104 accessible to the user computer 100 through the Internet 102, the user computer 100 can be located in many different positions and still have access to the server 104. An I/O handler 106 in the server 104 maintains security between the user computer 100 and the server 104 and handles all incoming requests from the user computer 100. The I/O handler 106 is effectively also a front-end program to pass requests from the user computer 100 to a database 108 in the server 104. An exemplary prior art system is the SimDesk system developed by SimDesk.

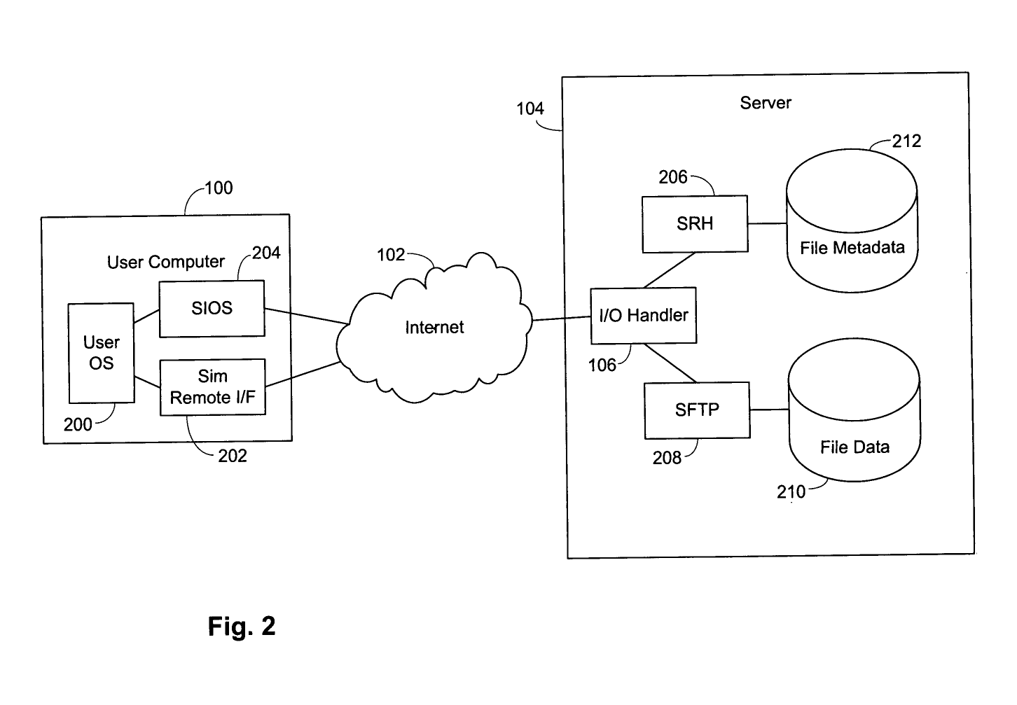

FIG. 2 illustrates various portions of the system of FIG. 1 in more detail. The user computer 100 contains a user operating system 200 such as Windows or Linux. This user operating system connects to the server 104 through the Internet 102 using one of two modules. A first module is a conventional remote interface module, such as a SimDesk remote interface module 202 as well known in the prior art. A second module is a SIOS or SimDesk input/output system module 204, which effectively has the server 104 appear as a series of folders mounted on a network drive for the user operating system 200. In this preferred embodiment the interface is preferred to be the SIOS module 204. The SIOS module 204 provides a request through the Internet 102 to the I/O handler 106. In this case in the preferred embodiment the I/O handler 106 separates the requests into metadata requests and actual file data requests. The metadata requests are provided to an SRH module 206, while the file data requests are provided to an SFTP module 208. The SFTP module 208 is connected to a binary file database 210, such that the SFTP module 208 provides binary transfers of actual full file data between a file data database 210 and the SIOS module 204. The SRH module 206 is connected to a file metadata database 210. The SRH module 206 thus provides metadata about the particular files as well as keeping track of the user rights to a particular file based on data contained in the file metadata database 212. Thus if the SIOS module 204 provides a file folder or file system query, this is processed by the SRH module 206, which then retrieves all of the folder, file and PIM item information accessible for the particular user from the database 212 and provides this to the SIOS module 204, which in turn provides this information to the user operating system 200.

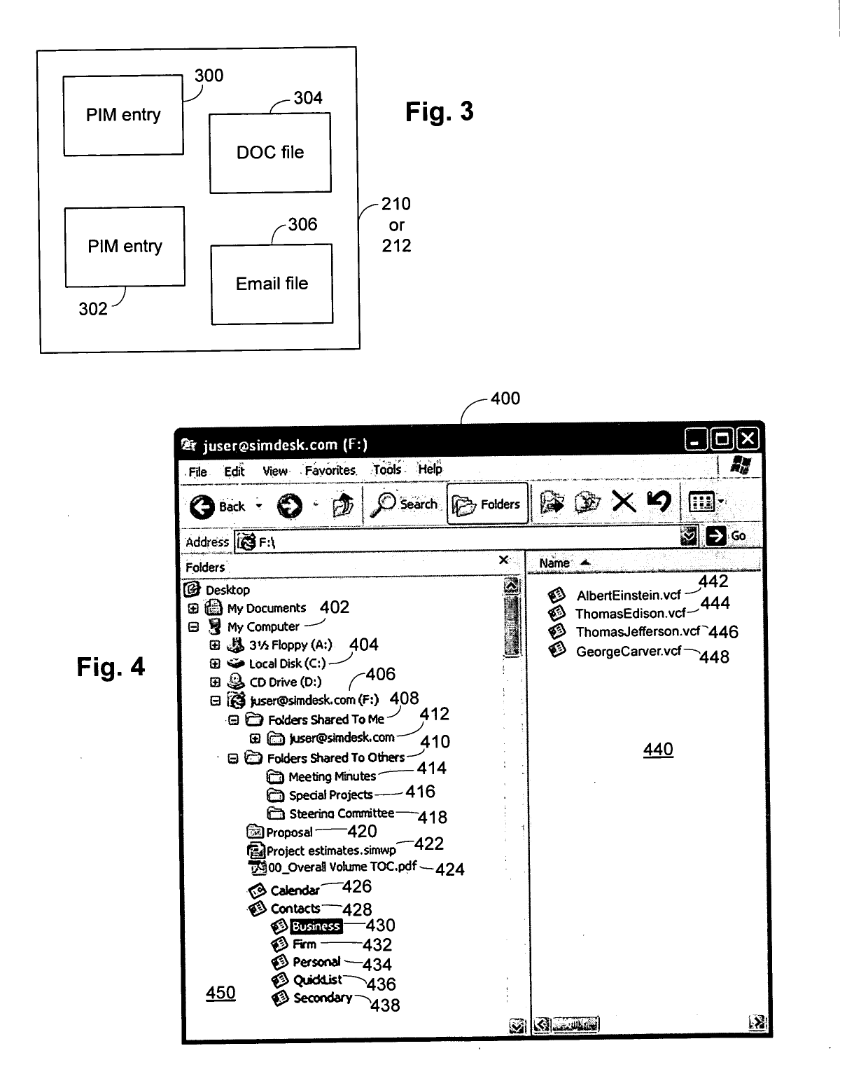

FIG. 3 is a block diagram of various files or entries contained in each of the databases 210 and 212. As shown there are a series of PIM entries 300 and 302, for example one being a contact entry and one being a calendar entry, a doc file as used in word processor and an email file as used in an email system 306.

FIG. 4 provides a screen shot 400 of the results of the file system query, such as by Windows Explorer, to the SIOS module 204 which provides file folder structure from the file metadata database 212 through the SRH module 206. As can be seen this is a typical Windows Explorer format with the entries under My Computer 402 expanded. For example, the local C: drive is element 404 and referred to as such. In the illustrated embodiment the server 104 is presented as the F: drive for juser@SimDesk.com element 406. Under this are various folders used in the preferred embodiment, such as Folder Shared To Me 408 and Folders Shared To Others 410. One of the advantages of the SimDesk system is that because files for all of the users are contained in a centralized server, sharing of folders provides a simple interchange between individual users. In the illustrated embodiment, the Folders Shared To Me 408 includes a folder juser@SimDesk.com 412, which is the folder of the actual user which is, of course, shared to herself. In the illustrated embodiment no other folders are shared by individuals to juser, so that the only folder shown under Folder Shared to Me 408 is the individual user folder 412. Various other folders are shown under Folders Shared To Others 410, such as Meeting Minutes 414, Special Projects 416, and Steering Committee 418. Normal SimDesk operating procedures would define which other individuals have access to those particular folders. After the Folder Shared To Others 410 are individual private folders belonging to juser. The first of these folders is a Proposal folder 420. Following that are individual files which are private to juser, such as Project Estimates 422 and Overall Volume TOC 424. Of most interest to the present invention are the entries after the private files. In this case a calendar entry folder 428 is shown in the file system, as is a contact folder 428 with various contact sub-folders: Business 430, Firm 432, Personal 434, Quicklist 436 and Secondary 438. As can be seen, these are calendar and contact or PIM items and they are shown in a conventional file manager display window. As described above, these are developed by having the SIOS module 204 query the SRH module 206 for the available file and folder items from the metadata database 212. These particular items are contained in the particular user's PIM items and are returned as individual format files in response to the query. Shown in the right hand pane 440 of the screen shot 400 are four individual contact items. In this case they are: Albert Einstein 442, Thomas Edison 444, Thomas Jefferson 446 and George Washington Carver 448. As can be seen, these are in .vcf or contact file interchange format. Thus to access the particular contact interchange format file a user uses Windows Explorer or similar file manager program, or a file manager associated with the operating system and used when opening files from inside another program, to display the desired folder in the left hand pane 450, with the individual items shown in the right hand pane 440. The user then selects the desired contact item, either by dragging and dropping or copying to a clipboard, for insertion in emails, documents or other items.

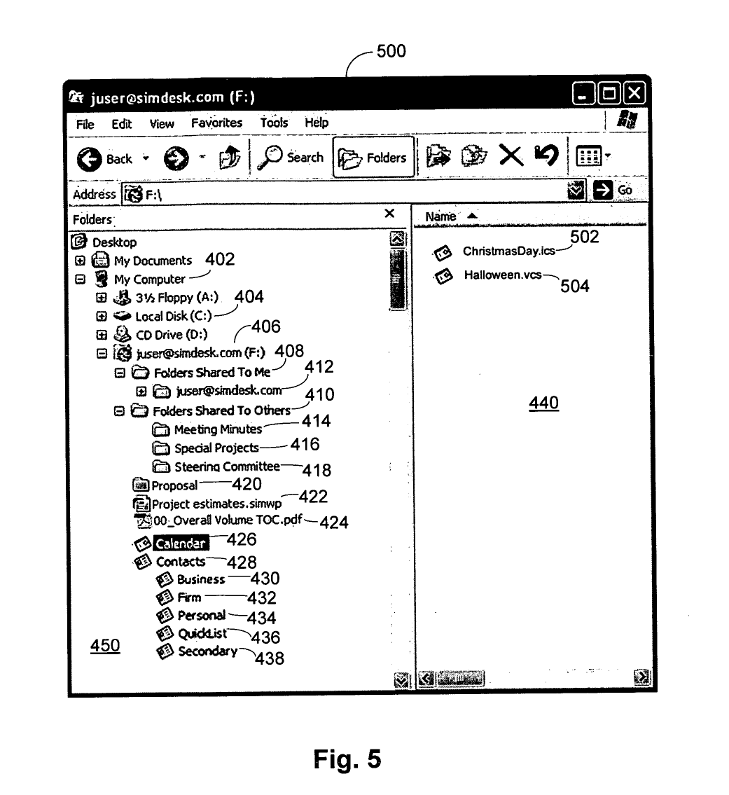

Proceeding then to FIG. 5, in this case calendar entries in the PIM database are shown. In FIG. 4 the business contact folder 430 was highlighted and had individual entries in the right pane 440, whereas in the example of the screen shot of 500 the calendar folder 426 is highlighted in the left pane 450 and in the right pane 440 are two calendar items: Christmas Day 502 and Halloween 504. Notice in this case, the Christmas Day file is an .ics format file while the Halloween file is a .vcs format file. The choice can be user defined or can be done by a particular setting communicated to the SRH module 206 or by system defaults. As in the operations according to FIG. 4, in operations of FIG. 5 a user need only copy or drag and drop a particular item 502 or 504 as desired into the particular email or file as desired.

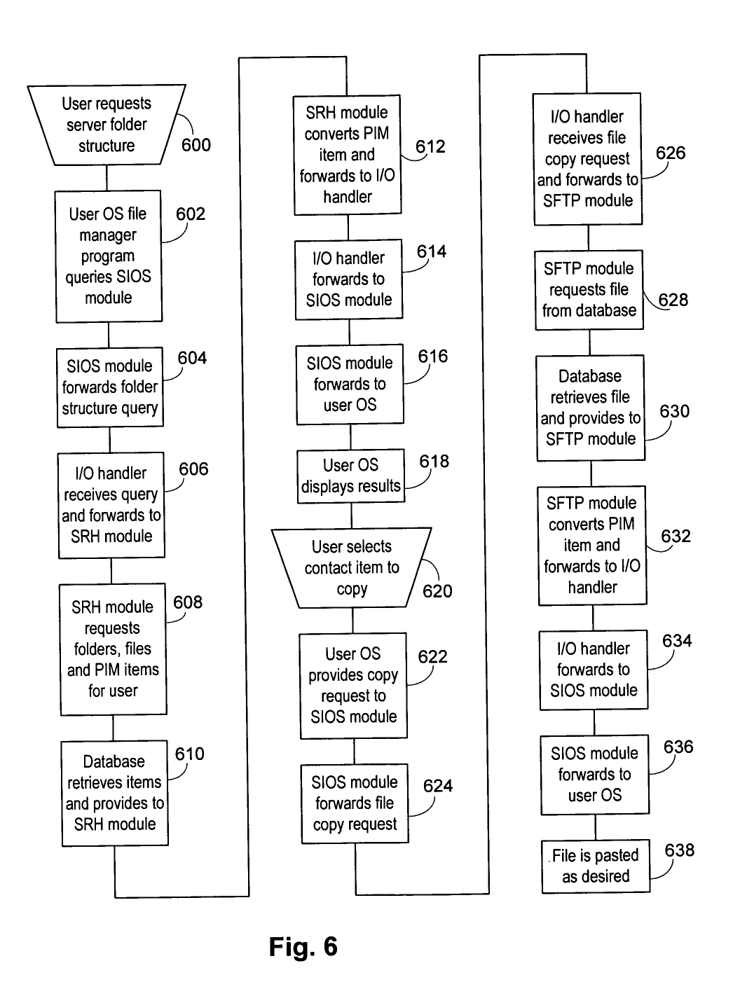

In the cases above, FIGS. 4 and 5, when the user does select a particular file to be copied or dragged and drop, the request for the full file data is transmitted from the SIOS module 204 to the I/O handler module 106. The I/O handler module 106 then transfers the request to the SFTP module 208 which retrieves the entire file data 210 from the file data database 210. The full process flow is described in more detail in FIG. 6.

FIG. 6 is a flowchart of an exemplary operation to determine a contact item and paste it. In step 600 the user requests the server folder structure. In step 602 the user operating system file manager program queries the SIOS module 204 with a file system query. In step 604 the SIOS module 204 forwards the folder structure query. In step 606 the I/O handler 106 receives the query and forwards it to the SRH module 206. In step 608 the SRH module 206 requests the folders, files and PIM items for the particular user. In step 610 the database 212 retrieves the various items requested by the SRH module 206 and provides them to the SRH module 206. In step 612 the SRH module 206 converts the retrieved PIM items into interchange format file values and forwards the retrieved folder and file items and converted PIM item interchange format file values to the I/O handler 106. In step 614 the I/O handler 106 forwards the retrieved items to the SIOS module 204. In step 616 the SIOS module 204 forwards the retrieved items to the user operating system 200. In step 618 the user operating system 200 displays the results for the user to review. In the indicated example, in step 620 the user then selects a particular contact item to copy. In step 622 the user operating system 200 provides the copy request to the SIOS module 204. In step 624 the SIOS module 204 forwards the file copy request. In step 626 the I/O handler 106 receives the file copy request and forwards it to the SFTP module 208. In step 628 the SFTP module 208 requests the entire file from the database 210, the PIM item being stored as a file in the file database 210. In step 630 the database 210 retrieves the file and provides it to the SFTP module 208. In step 632 the SFTP module 208 converts the PIM item into the desired interchange file format and forwards the file to the I/O handler 106. In step 634 the I/O handler 106 forwards the file to the SIOS module 204. In step 636 the SIOS module 204 forwards the file to the user operating system 200. In step 638 the retrieved file is then pasted as desired by the user. As can be seen, this is a very efficient and simple way to paste a contact item or calendar item if desired, as compared to the prior art techniques.

Thus the operations to allow cutting, pasting, insertion and otherwise transfer of PIM items in interchange file formats are simplified in operations according to the present invention.

While the above described preferred embodiment utilizes a server system with separated metadata and file data as used in the SimDesk system, other PIM databases, such as Microsoft Exchange or other MAPI server, could be utilized in conjunction with an intermediate program having the functions of the SRH and SFTP modules. Further, while the described preferred embodiment utilizes a server system, single computer arrangements, such as Microsoft Outlook, can also utilize the invention by providing an intermediate program or module between the file manager program, such as Windows Explorer, and the Outlook .pst files which contain the user data.

While the above described embodiment utilizes separate I/O handler, SRH and SFTP modules, it is understood that the functions of these modules can be merged or further segregated as desired. For example, in certain embodiments the SRH and SFTP modules can be merged into a single module. Likewise, the metadata database and data file database can be merged or further segregated if desired. In one example a merged SRH and SFTP module can interact with a merged metadata and data file database. Such an example would be useful in the case of a single computer where the relevant database is an Outlook .pst file.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for displaying personal information management (PIM) items contained in a database as files, the method comprising:
receiving a file system structure query directed to the database;
retrieving PIM item information from the database in response to said file system structure query; and
providing said retrieved PIM item information in an interchange format file form for display.

2. The method of claim 1, further comprising:
providing a file system structure query directed to the database from a file management program; and
receiving said retrieved PIM item information in interchange format file form and displaying it with a file management program for user review.

3. The method of claim 2, further comprising:
receiving a request for a selected PIM item interchange format file;
retrieving the information for the requested PIM item interchange format file from the database; and
providing said retrieved information for the requested PIM item interchange format file in an interchange format file.

4. The method of claim 3, further comprising:
providing a request for a selected PIM item interchange format file, the selection being for a PIM item interchange format file displayed by the file management program.

5. The method of claim 4, wherein said steps of providing are performed between two computers over a network.

6. The method of claim 5, wherein the network includes the Internet.

7. The method of claim 3, wherein said steps of providing are performed between two computers over a network.

8. The method of claim 7, wherein the network includes the Internet.

9. The method of claim 2, wherein said steps of providing are performed between two computers over a network.

10. The method of claim 9, wherein the network includes the Internet.

11. A system for displaying personal information management (PIM) items contained in a database as files, the system comprising:
a database containing PIM items;
an intermediate code module; and
a database code module coupled to said intermediate code module and to said database,
wherein said intermediate code module receives a file system structure query directed to the database;
wherein said database code module retrieves PIM item information from the database in response to said file system structure query; and
wherein said intermediate code module provides said retrieved PIM item information in an interchange format file form for display.

12. The system of claim 11, further comprising:
a file management module coupled to said intermediate code module,
wherein said file management module:
provides a file system structure query directed to said database; and
receives said retrieved PIM item information in interchange format file form and displays it for user review.

13. The system of claim 12, further comprising:
an intermediate code file module coupled to said database code module,
wherein said intermediate code file module receives a request for a selected PIM item interchange format file;
wherein said database code module retrieves the information for the requested PIM item interchange format file from the database; and
wherein said intermediate code file module provides said retrieved information for the requested PIM item interchange format file in an interchange format file.

14. The system of claim 13, wherein said intermediate file code module is coupled to said file management module, and wherein said file management module provides a request for a selected PIM item interchange format file, the selection being for a PIM item interchange format file displayed by said file management module.

15. The system of claim 14, further comprising:
first and second computers for interconnection over a network,
wherein said first computer includes said database, said intermediate code module and said intermediate file code module, and
wherein said second computer includes said file management module.

16. The system of claim 15, wherein the network includes the Internet.

17. The system of claim 13, further comprising:
first and second computers for interconnection over a network,
wherein said first computer includes said database, said intermediate code module and said intermediate file code module, and
wherein said second computer includes said file management module.

18. The system of claim 17, wherein the network includes the Internet.

19. The system of claim 12, further comprising:
first and second computers for interconnection over a network,
wherein said first computer includes said database, said intermediate code module and said intermediate file code module, and
wherein said second computer includes said file management module.

20. The system of claim 19, wherein the network includes the Internet.

21. A computer readable medium or media having computer-executable instructions stored therein for an application which performs the following method for displaying personal information management (PIM) items contained in a database as files, the method comprising:
receiving a file system structure query directed to the database;
retrieving PIM item information from the database in response to said file system structure query; and
providing said retrieved PIM item information in an interchange format file form for display.

22. The computer readable medium or media of claim 21, the method further comprising:
providing a file system structure query directed to the database from a file management program; and
receiving said retrieved PIM item information in interchange format file form and displaying it with a file management program for user review.

23. The computer readable medium or media claim 22, the method further comprising:
receiving a request for a selected PIM item interchange format file;
retrieving the information for the requested PIM item interchange format file from the database; and
providing said retrieved information for the requested PIM item interchange format file in an interchange format file.

24. The computer readable medium or media claim 23, the method further comprising:
providing a request for a selected PIM item interchange format file, the selection being for a PIM item interchange format file displayed by the file management program.

25. The computer readable medium or media claim 24, wherein said steps of providing are performed between two computers over a network.

26. The computer readable medium or media claim 25, wherein the network includes the Internet.

27. The computer readable medium or media claim 23, wherein said steps of providing are performed between two computers over a network.

28. The computer readable medium or media claim 27, wherein the network includes the Internet.

29. The computer readable medium or media claim 22, wherein said steps of providing are performed between two computers over a network.

30. The computer readable medium or media claim 29, wherein the network includes the Internet.
